(19) United States
(12) Patent Application Publication
(10) Pub. No.: US 2003/0105684 A1
(43) Pub. Date: Jun. 5, 2003

(54) Allocating inventory based on allocation priorities

(75) Inventors: Robert M. Dunn, Toronto (CA); Lev Mirlas, Thornhill (CA); George H. Moryadas, Boston, MA (US)

Correspondence Address: Jeffrey S. LaBaw, International Business Machines, 11400 Burnet Rd., Austin, TX, 78758, US

(73) Assignee: INTERNATIONAL BUSINESS MACHINES CORPORATION, ARMONK, NY

(21) Appl. No.: 10/242,570

(22) Filed: Sep. 12, 2002

(30) Foreign Application Priority Data
Nov. 30, 2001 (CA) 2,364,121

(51) Int. Cl. G06F 17/60

(52) U.S. Cl. 705/28

(57) ABSTRACT

The present invention provides a method for allocating inventory of a supplier to contracted requestors based on allocation priorities. The supplier sets up a distribution arrangement (contract) with each requestor interested in obtaining inventory. Each inventory record identifies a pool of available inventory. Under a distribution arrangement (between the requestor and the supplier), one or more availability records are associated (by the supplier) with the distribution arrangement. An availability record identifies an inventory record from which inventory will be allocated (to a requestor). A supplier allocates inventory (to a requestor) from a pool of inventory identified by an inventory record associated with an availability record (the availability record indicates that inventory is to be allocated from the pool of inventory identified with the inventory record) assigned (by the supplier) under a distribution arrangement. Each availability record indicates an allocation priority relative to other availability records.

### FIELD OF THE PRESENT INVENTION

This invention relates to allocating inventory, and more specifically to allocating inventory from a pool of available inventory to requestors based on allocation priorities.

### BACKGROUND

Suppliers of inventory (organizations that supply product and/or services such as, distributors, wholesalers, or manufacturers and the like) allocate inventory by reserving portions of inventory to organizations or entities that request inventory (such as resellers, end users, renters, buyers of product and/or services, hereinafter referred to as ‘requestors’). Inventory can be items such as fish, fruit, computer components, or pens and pencils and the like, or can be services.

From time to time, a supplier of inventory may unfortunately reserve a portion of inventory to slow-turnover requestors (that is requestors that very slowly turnover their reserved portion of inventory). Sometimes, the supplier may be fortunate to reserve another portion of inventory to fast-turnover requestors (that is requestors that quickly turnover their reserved portion of inventory). The portion of inventory reserved for slow-turnover requestors will become stagnant while the portion of inventory reserved for fast-turnover requestors avoids becoming stagnant. The supplier (hereinafter referred to as ‘distributor’) of inventory is prevented from reassigning reserved portions of stagnant inventory over to quick-turnover requestors because the distributor will then suffer the consequence of souring a business relationship with a desirable, fast-turnover requestor (who expects to receive fresh inventory). When portions of reserved inventory become stagnant, the distributor will experience increased costs for carrying the stagnant inventory and then might be unable to recuperate from these losses when the stagnant inventory is eventually sold. Quick-turnover requestors can become disadvantageously prevented or blocked from obtaining inventory allocated or reserved for slow-turnover resellers (thus potentially creating a backlog for the quick-turnover requestor). It is not desirable for a distributor to endure cost increases when portions of reserved inventory age and are not turned over (that is picked or removed) quickly. Additionally, requestors and distributors may be required to each individually operate an inventory management system, which would be an expensive proposition for the requestors. Accordingly, an improvement for allocating inventory would be beneficial.

### SUMMARY

The present invention enables a supplier or distributor of inventory to allocate inventory from available pools of inventory to requestors based on a priority sequence identified by the supplier. A distribution arrangement is setup between the supplier and each requestor. The distribution arrangement specifies that the supplier will allocate inventory to the requestor identified in the distribution arrangement. Subsequently, the supplier (under each distribution arrangement) associates one or more availability records wherein each associated availability record identifies one inventory record (each inventory record identifies one pool of inventory) from which inventory will be allocated. Each availability record includes an allocation priority indicator for indicating relative priority between other associated availability records. Inventory is allocated from an inventory record identified by an availability record having a preferred priority indication. The priority indicators indicate a preferred priority sequence for allocating inventory from available pools if inventory. A distribution arrangement specifies a preferred priority sequence for allocating inventory.

Once a supplier receives a shipment of inventory, an inventory record is created for identifying the received shipment of inventory (or a portion of inventory). An inventory record specifies the current quantity of available inventory, the cost, and date the inventory was received. Once all the pools of available inventory are identified by an inventory record, availability records are created for identifying one inventory record. An availability record indicates that inventory identified by an inventory record is allocatable under a particular distribution arrangement. Each availability record also indicates priority relative to other availability records in which allocation of inventory is based on the priority level of an availability record.

When a requestor requests inventory from a supplier, the supplier refers to an availability record under the distribution arrangement between supplier and requestor, and subsequently picks allocated inventory associated with the availability record having the preferred priority indication. The supplier may use one or more availability records for identifying one or more existing inventory records and thus permit allocation of inventory depending on the priority level if an availability record.

In a first aspect of the invention there is provided a method of selectively apportioning inventory of supplies of a supplier to contracted entities having distribution arrangements with the supplier, including creating a record of supplies received in the inventory, from the record of receipt creating availability records of the received supplies for the contracted entities in accordance with the distribution arrangements, and allocating supplies from the inventory to a contracted entity submitting an order for supplies in accordance with an availability record of the supplies for the contracted entity.

In a second aspect of the invention there is provided a system for selectively apportioning inventory of supplies of a supplier to contracted entities having distribution arrangements with the supplier, the system including means for creating a record of supplies received in the inventory, means for creating availability records of the received supplies from the record of receipt for the contracted entities in accordance with the distribution arrangements, and means for allocating supplies from the inventory to a contracted entity submitting an order for supplies in accordance with an availability record of the supplies for the contracted entity.

In a third aspect of the invention there is provided computer program product for use in a computer system operatively coupled to a computer readable memory, the computer program product including a computer-readable data storage medium tangibly embodying computer readable program code for directing the computer to selectively apportion inventory of supplies of a supplier to contracted entities having distribution arrangements with the supplier, the computer program product including code for instructing the computer system to create a record of supplies received in the inventory, code for instructing the computer system to create availability records of the received supplies from the record of receipt for the contracted entities in accordance with the distribution arrangements, and code for instructing the computer system to allocate supplies from the inventory to a contracted entity submitting an order for supplies in accordance with an availability record of the supplies for the contracted entity.

A better understanding of these and other embodiments of the present invention can be obtained with reference to the following drawings and description of the preferred embodiments.

### BRIEF DESCRIPTION OF THE DRAWINGS

The embodiments of the present invention will be explained by way of the following drawings:

FIG. 1 depicts an inventory allocation environment;

FIG. 2 depicts an inventory allocation system embodying aspects of the present invention;

FIG. 3 depicts operations for allocating inventory related to the inventory allocation system of FIG. 2; and

FIG. 4 depicts operation for setting up the inventory allocation system of FIG. 3.

### DETAILED DESCRIPTION

Background

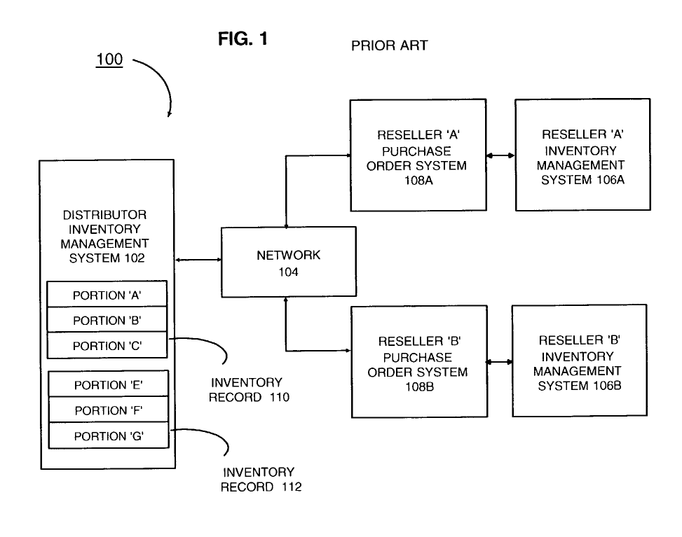

FIG. 1 depicts distribution environment 100 including inventory management (IM) system 102 operated by a distributor, Inventory Management system 106A and purchase order (PO) system 108A both operated by reseller ‘A’, Inventory Management system 106B and Purchase Order system 108B both operated by reseller ‘B’. Inventory Management system 102, and Purchase Order systems 108A, 108B are operatively networked via network 104 such as the Internet. It will be appreciated that an Inventory Management system can be a subsystem of a larger business system such as an ERP (Enterprise Resource Planning) system. ERP systems generally include integrated subsystems each dedicated for managing specific facets of business operations such as an inventory subsystem, a planning subsystem, a manufacturing subsystem, a sales subsystem, or an accounting subsystem.

Resellers ‘A’ and ‘B’ use their respective Purchase Order systems 108A, 108B to place purchase orders. Purchase Order system 108A may allocate inventory from reseller ‘A’ Inventory Management system 106A, may allocate inventory from a distributor's Inventory Management system 102, or may initially allocate inventory from reseller ‘A’ Inventory Management system 106A and then proceed to allocate inventory from the distributor's Inventory Management system 102 (for the case when Inventory Management system 106A cannot fulfill any purchase orders). Similarly, Purchase Order system 108B may allocate inventory from reseller ‘B’ Inventory Management system 106B or may allocate inventory from the distributor's Inventory Management system 102. For the case when the distributor receives requests to allocate inventory, Inventory Management system 102 arranges for the fulfillment of the received purchase orders and may transmit messages pertaining to purchase and/or shipment confirmations back to respective Inventory Management systems 106A, 106B.

Inventory Management system 102 includes memory (not depicted) for maintaining inventory records 110 and 112. Inventory record 110 indicates or depicts a quantity of inventory received on a specific date (such as September 1). Inventory record 112 indicates another quantity of inventory received on another specific date (such as September 3). When a distributor receives a shipment of inventory, the distributor allocates inventory by exclusively reserving portions of the received shipment of inventory to corresponding resellers. For example, portions ‘A’, ‘B’, and ‘C’ of inventory record 110 represent portions of inventory reserved for resellers ‘A’, ‘B’, and ‘C’ respectively (reseller ‘C’ is not depicted). Portions ‘E’, ‘F’, and ‘G’ of inventory record 112 represent portions of inventory reserved for resellers ‘A’, ‘B’, and ‘C’ respectively. Inventory related to inventory record 110 is older than inventory related to inventory record 112.

Preferred Embodiments

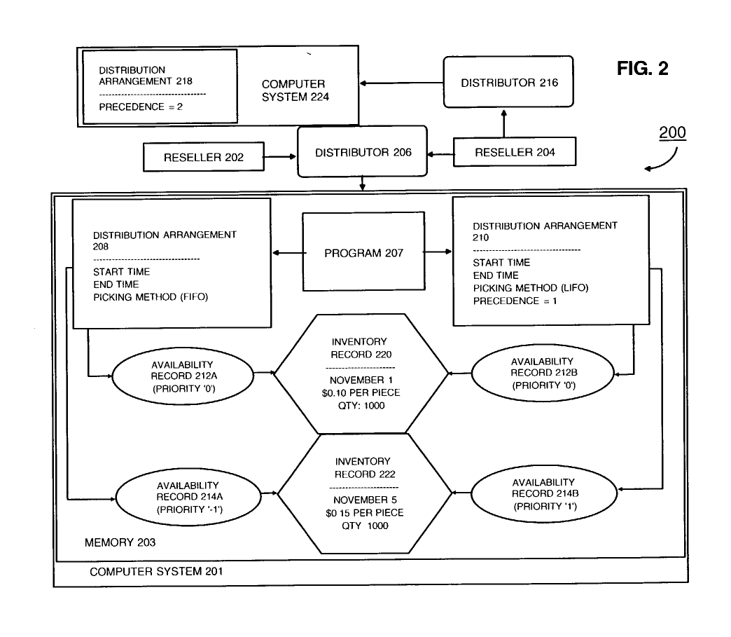

FIG. 2, depicts an inventory allocation environment 200 including resellers 202 and 204, distributors 206 and 216, computer systems 201 and 224. In a preferred embodiment, distributors 206, 216 operate computer system 201, 224 respectively to allocate inventory for fulfilling purchase orders related to various resellers (i.e., environment 200 is operated or implemented in a distributed computing environment).

In an alternative embodiment (not depicted), distributors 206 and 216 interact with a single computer system (i.e., environment 200 is operated on a computer system that accommodates a plurality of distributors in which another business entity owns and/or operates the inventory management system, and the plurality of distributors pay user fees for using the computer system. User fees represent one business model. For example, another business model does not involve user fees in which a manufacturer may provide inventory allocation service for reseller channels. Reseller 202 is prepared to place purchase orders with distributor 206. Reseller 204 is prepared to place purchase orders with distributor 206 and/or distributor 216. In a preferred embodiment, resellers 202 and 204 can be e-commerce stores operating from within an adapted version of Webshpere™ Commerce Suite supplied by IBM of Armonk, N.Y.

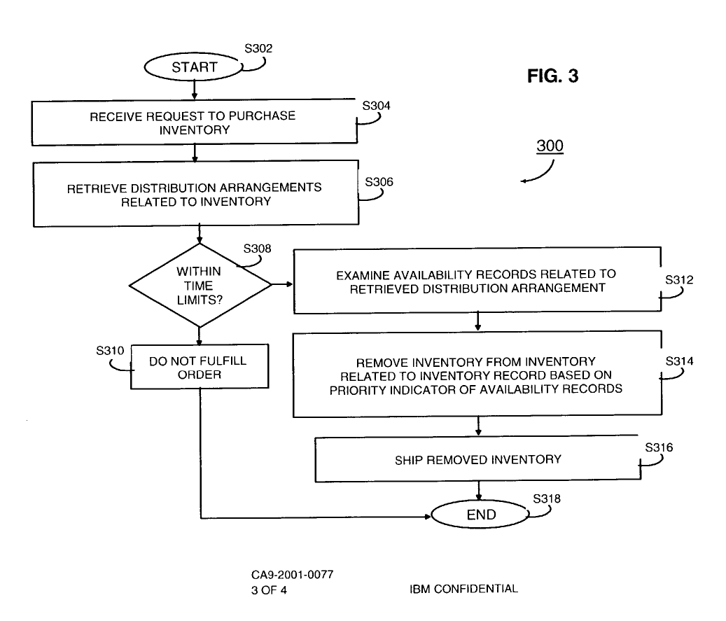

Computer system 201 includes computer-readable memory 203 operatively coupled to a CPU (Central Processing Unit, not depicted). Memory 203 stores computer software program 207, distribution arrangements 208, 210, availability records 212A, 212B, 214A, 214B, and inventory records 220, 222. Computer software program 207 includes computer-programmed instructions for instructing or directing the CPU to achieve specific tasks or operations as depicted in FIG. 3 and as described in the following description.

Computer system 224 includes computer-readable memory (not depicted) operatively connected to a CPU (not depicted). The memory stores distribution arrangement 218 and computer software program 207 (however, program 207 is not depicted as being stored in computer program system 224).

Distribution arrangements 208, 210 specify inventory allocation priorities to distributor 206 for fulfilling purchase orders received from resellers 202, 204 respectively. Distribution arrangement 218 specifies inventory allocation priorities to distributor 216 for fulfilling purchase orders received from reseller 204.

Resellers 202 and 204 place or submit purchase orders (not depicted) for purchasing inventory, such as pencils, from distributor 206. Distributor 206 uses computer system 201 to select allocated inventory for fulfilling received purchase orders. For the case when distributor 206 receives purchase orders from resellers 202 and 204, distributor 206 removes inventory related to inventory records. Portions of an inventory record are not specifically allocated to any specific resellers, as will be shown below. In an alternative embodiment, a distributor does not directly ship inventory to resellers, in which case the distributor is a re-supplier for resellers.

Prior to placing or receiving any purchase orders, reseller 202 and distributor 206 set up distribution arrangement 208 that specifies a FIFO picking method, and reseller 204 and distributor 206 set up distribution arrangement 210 that specifies a different, in this case LIFO, picking method. Distribution arrangements 208 and 210 specify that distributor 206 agrees to sell and/or supply inventory to reseller 202, 204 respectively. In a preferred embodiment, a distribution arrangement is valid or enforceable from a starting time to an ending time (for example, a distribution arrangement can be valid from August 1 to December 31). In another preferred embodiment, a distribution arrangement specifies a method for picking or removing inventory related to various inventory records. Examples for picking or removing inventory are FIFO (First In First Out) method and LIFO (First In Last Out) method. The FIFO method ensures that older inventory is picked until completely exhausted before picking newer inventory. The LIFO method ensures that newer inventory is picked until completely exhausted before picking older inventory. In an alternative embodiment, resellers do not place their purchase orders with a distributor, in which case the resellers pick or remove inventory controlled by the distributor.

Distributor 206 receives a shipment of inventory on November 1 and subsequently creates inventory record 220. Inventory record 220 represents a quantity of inventory which distributor 206 will use to fulfill purchase orders received from various resellers. For the case when distributor 206 decides to pick or remove inventory related to inventory record 220 to fulfill purchase orders received from resellers 202 and 204, distributor 206 produces availability records 212A and 212B that are associated to respective resellers 202 and 204 (under respective distribution arrangements 208 and 210). Availability records 212A and 212B indicate that distributor 206 desires to fulfill purchase orders received from resellers 202 and 204 respectively by picking or removing inventory related to inventory record 220. In a preferred embodiment, portions of inventory related to inventory record 220 are not specifically allocated or reserved for resellers, and that inventory as a whole is allocated to one or more resellers (as deemed suitable by a distributor).

In a preferred embodiment, an availability record has an associated priority number for indicating priority or preference for picking inventory from the availability record versus picking from inventory related to other availability records. Availability record 212A (which has a priority number of ‘0’) indicates that for the case when reseller 202 (which is associated with distribution arrangement 208) places purchase orders for inventory, distributor 206 will pick or remove the inventory related to inventory record 220, and then arrange for the shipment of the removed inventory to reseller 202 (before picking or removing inventory related to any other availability records having a lower priority attribute that may exist under distribution arrangement 208). Availability record 212B (which has a priority number of ‘0’) indicates that for the case when reseller 204 (which is associated with distribution arrangement 210) places purchase orders for inventory, distributor 206 will pick or remove the inventory related to inventory record 220, and then ship the removed inventory to reseller 204 (before picking inventory related to any other availability records having a lower priority attribute that may exist under distribution arrangement 210).

It will be appreciated that specific portions of inventory related to an inventory record are not expressly reserved for fulfilling purchase orders from specific resellers. Any inventory related to an inventory record can be picked or removed for fulfilling purchase orders received from resellers provided that a distributor has associated an availability record under an appropriate distribution arrangement between the distributor and the resellers. By not specifically reserving portions of inventory for specific resellers, portions of inventory are prevented from becoming stagnant because the inventory is picked based on a first-come-first-served basis when a purchase order is received from the resellers.

In an alternative embodiment, cost of inventory is associated with an inventory record. All inventory related to an inventory record have the same cost. For example, a shipment of 1,000 pencils has been received by a distributor. The unit cost for a quantity of 750 pencils is $1.00, and the unit cost for a quantity of 250 pencils is $1.10 (the price increased, but the shipment includes the combination of expensive and inexpensive pencils). In this case, the distributor would create for the single physical shipment two distinct inventory records, in which each distinct inventory record will have a related per unit cost.

There could be other reasons why a single shipment may be broken down into multiple inventory records. For example, a distributor receives a large shipment of 100,000 pencils. The distributor has some distribution arrangements that limit the quantity of inventory available to 10,000 pencils. If such a huge shipment of inventory were related to a single inventory record, then all those resellers with limited-quantity arrangements (that is restricted or limited as to the maximum quantity of pencils) could not be given access to such a single large quantity of inventory. To limit resellers, a distributor may decide to create 20 subgroups of inventory, in which each subgroup includes 5,000 pencils and the subgroups of inventory are then related to various inventory records. For this case, the distribution arrangement provides a method for limiting quantity of inventory related to various inventory records.

A distribution arrangement is a record indicating that a reseller may allocate inventory from various inventory records (which are held or controlled by a distributor). The distribution arrangement can specify a distributor (that is an entity that manages or owns allocatable inventory records available under the distribution arrangement), a reseller (that is an entity that has a right to pick or select inventory related to various allocatable inventory records available under the distribution arrangement), an indication of a start time (that is the time the distribution arrangement becomes valid or effective), an indication of an end time (that is the time the distribution arrangement stops being effective or become invalid), a picking or an availability customization method (that is the manner in which inventory is to be picked or removed from various groups of inventory), and a precedence indicator (that is a distributor selection indication assigned by a reseller for selecting a preferred distribution arrangement from a group of available distribution arrangements based on a criteria, such as lowest cost supplier of inventory).

Resellers may create and modify precedence indicators related to various distribution arrangements available to the resellers. In a preferred embodiment, the precedence indicator is not created and/or modified by the distributor. Alternatively, the precedence indicator is created and/or modified by the distributor, in accordance with a preference indicated by a reseller (that is on behalf of the reseller).

An availability record indicates that inventory has been made available for allocation by a distributor, in which the available inventory is related to an inventory record. An availability record is created under a distribution arrangement. The availability record has a priority indicator for indicating a sequence in which inventory is to be picked from various groups of inventory. The priority of an availability record is normally set by the distributor, according to the picking or availability customization method for the distribution arrangement, to indicate the order in which inventory is allocated for a reseller from the inventory records.

Distributor 206 receives another shipment of inventory on November 5 and subsequently creates inventory record 222 related to the shipment of inventory. Distributor 206 decides that to fulfill future purchase orders from resellers 202 and 204, distributor 206 will pick or remove inventory related to inventory record 222 in addition picking or removing inventory related to inventory record 220 (that is there are now several groups of inventory to pick therefrom). For the case when distributor 206 desires to allow picking from inventory related to inventory record 222, distributor 206 produces availability record 212B and 214B to indicate that distributor 206 can also fulfill purchase orders from resellers 202 and 204 (respectively) by removing inventory related to inventory record 222. Now distributor 206 has several available inventory records (such as inventory records 220 and 222) from which to pick or remove inventory for fulfilling purchase orders depending on which availability records exist and the priority indicators related to the availability records.

For the case when distributor 206 receives purchase orders for inventory from reseller 202 under distribution arrangement 208 and since availability record 212A indicates a priority ‘0’ status and availability record 214A indicates priority status ‘−1’, then distributor 206 picks inventory related to inventory record 220 for fulfillment of the purchase order (because availability record 212A has a related priority of ‘0’ which is the highest priority of the availability records for this distribution arrangement. For the case when inventory record 220 indicates no more inventory is present, distributor 206 picks inventory related to inventory record 222 (because availability record 214B has a related priority of ‘−1’ which is the highest priority of the availability records associated with available inventory for this distribution arrangement) for fulfillment of the purchase order. Under a FIFO picking method, priorities are assigned to availability records in such a way that newer availability records have lower priority. It will be appreciated that records that eventually indicate no inventory can be removed from computer system 201.

In the preferred embodiment, inventory related to a preferred inventory record is removed on the basis of the priority indicated for an availability record. For example, the manner in which inventory is removed can be specified in distribution arrangement 208, which is set for a FIFO picking method. For the case when distributor 206 prefers to remove inventory in the FIFO manner, inventory related to inventory record 220 is entirely removed before removing any inventory related to inventory record 222 (because inventory record 220 is older than inventory record 222). Once inventory related to inventory record 220 is depleted, then inventory related to inventory record 222 can be removed. This is advantageous when distributor 206 wishes to deplete older or aged inventory before picking newer or fresher inventory. Older inventory is indicated by an older date (such as November 1 for inventory record 220). Newer inventory is indicated by a newer date (such as November 5 for inventory record 222).

The priority of availability records is set to reflect a picking method. Thus, the picking method is only looked at when inventory records and the corresponding availability records are created. During inventory allocation (which is a performance-critical process since it happens very frequently with a large volume of transactions) all that needs to be looked at is availability record priorities. These are meant to be already set up in such a way as to respect the appropriate picking algorithm.

Under the LIFO picking method, newer inventory will be picked and depleted before picking older inventory. Availability record 214B (which has a priority indication of ‘1’ which indicates newest inventory) indicates that for the case when reseller 204 associated with distribution arrangement 210 places purchase orders for inventory, distributor 206 will remove inventory related to inventory record 222 (because related availability record 214B has a priority indication of ‘1’). However, for the case when inventory record 222 indicates no more related inventory is available for picking, distributor 206 will pick inventory related to inventory record 220 (because the priority status of availability record 212B is set to ‘0’ which indicates the next available newest inventory). The manner in which inventory is picked by distributor 206 is specified in distribution arrangement 210 related to reseller 204. For example, the manner of picking inventory is specified as the LIFO picking method.

An example for using the FIFO picking method is for the case when distributor 206 wishes to pick inventory related to inventory record 220 before picking inventory related to inventory record 222. Initially, inventory related to inventory 220 is picked until completely depleted. For the case when inventory has been completely depleted from inventory related to inventory record 220, then inventory related to inventory record 222 is picked. The LIFO picking method requires that newer inventory related to inventory record 222 is picked before inventory related to inventory record 220 is picked.

It will be appreciated that the inventory (or portions of inventory) related to inventory records 220 or 222 are not reserved for or allocated to any specific resellers. Rather, inventory related to inventory records are made available for picking provided that a distributor refers to availability records related to the specific resellers.

In the preferred embodiment, distribution arrangements further include precedence indicators. Reseller 204 can place purchase orders with either distributor 206 or distributor 216. Distributor 206 and reseller 204 have previously set up distribution arrangement 210. Distributor 216 and reseller 204 set up distribution arrangement 218. Reseller may be motivated to place purchase orders with distributor 216 because distributor 216 provides an incentive to reseller 204, such as lower-cost inventory or a sales incentive promotion (such as a free trip to Hawaii, or may reflect the distributor reliability). Reseller 204 sets the precedence indicator related to distribution arrangement 218 to a value of ‘2’ to indicate that purchase orders will be initially placed with distributor 216. Reseller 204 sets the precedence indicator related to distribution arrangement 210 to a value of ‘1’ to indicate that purchase orders will be placed with distributor 206 when distributor 216 cannot fulfill any purchase orders. Higher precedence distribution arrangements are given preference.

FIG. 3 depicts operations of computer program 207 of FIG. 2 for allocating inventory. It is understood that the operations depicted in flowchart 300 will be performed by program 207 operating in computer system 201 unless stated otherwise.

S302 indicates the start of operations of the IM system. S304 indicates that IM system receives a request to purchase inventory. In S306, the IM system retrieves distribution arrangements related to the inventory specified in the purchase order. In S308, the IM system determines whether the retrieved distribution arrangements have sufficient inventory to fulfill the request, and are valid or enforceable because the purchase order was received when the specified start and stop times are still valid or acceptable. If no, processing continues to S310 (in which case the order is not fulfilled and processing stops because the purchase order was received either before or after the time that the distribution arrangements are valid). If yes, processing continues to S312 (in which case inventory will be selected from inventory related to the inventory records because the purchase order was received during the time that the distribution arrangements are enforceable or valid).

In S312, the IM system examines availability records related to the selected distribution arrangements. In S314, the IM system selects inventory related to inventory records from which to remove inventory (based on priority indicator related to the availability records). In S316, the IM system proceeds with arranging the shipping of inventory from the selected inventory record. In S318, operations end.

In the preferred embodiment, a distribution arrangement can specify a maximum quantity of inventory that can be allocated to a reseller. For example, when the maximum quantity of inventory is 500 and the received shipment of inventory has a quantity of 1000, then an availability record cannot be used for assigning or allocating inventory to the received shipment of inventory because the quantity (of the received shipment of inventory) is larger than the maximum quantity permitted (by the distribution arrangement). In this embodiment, a distributor would need to either split the received inventory into smaller chunks or increase the inventory limit for a reseller.

In an alternative embodiment, a distribution arrangement can specify a precedence value so that a reseller can place their purchase order with a preferred distributor. For example, a reseller can have two distributors with which to place purchase orders. The reseller may assign a precedence value of ‘2’ to indicate a first preferred distributor (with which to place purchase orders), and a precedence value of ‘1’ to indicate a second preferred distributor (with which to place a purchase order when the first preferred distributor cannot fulfill a purchase order). When the reseller is ready to place a purchase order, the order will be placed with the distributor having the highest precedence value. For the case when the distributor cannot fulfill the purchase order, then the purchase order is placed with the distributor having the next highest precedence value.

It will be appreciated that the embodiments of the present invention can be implemented on a hosted computer environment or can be implemented on a distributed computer environment.

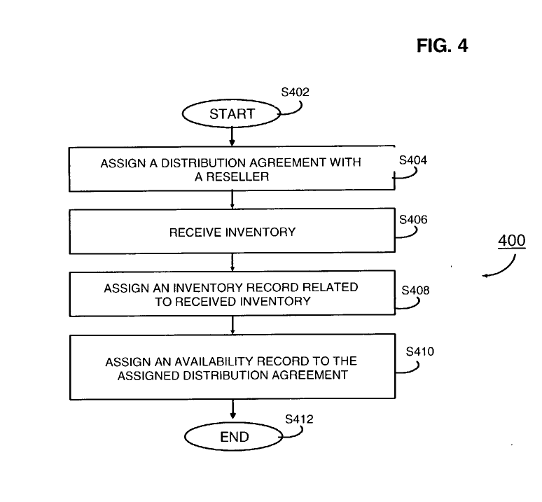

Referring to FIG. 4, there is depicted operations of computer program 207 of FIG. 2 for directing the CPU related to computer system 201 for setting up an allocation environment. It is understood that the operations depicted in flowchart 300 will be performed by computer program 207 operating in memory of computer system 201 unless stated otherwise.

In S402, operations of computer program 207 begins. In S404, computer program 207 (stored in memory 203) is directed by distributor 206 to setup and/or assign distribution arrangement 208 between distributor 206 and reseller 202, and to assign distribution arrangement 210 between distributor 206 and reseller 204.

In S406, distributor 206 receives inventory or a shipment of inventory. In S408, computer program 207 is directed by distributor 206 to setup and/or assign an inventory record related to the received inventory. For example, distributor 206 assigns inventory record 220 related to the received inventory record, which was received on November 1.

In S410, computer program 207 is directed by distributor 207 to setup and/or assign an availability record to the assigned distribution arrangement. For example, once inventory record 220 is assigned to the received inventory, availability record 212A is created and assigned to distribution arrangement 208 which would allow allocation of inventory related to inventory record 220 for fulfillment of purchase orders received from reseller 202. In S412, operations of computer program 207 stops. It will be appreciated that flowchart 400 can be adapted to determine whether operations S402, S404, S408, and S410 should be performed prior to performing any of these operations. For example, prior to executing operation S408, flowchart 400 can include an operation to determine whether there are any distributions agreements that an availability record can be assigned thereto (with corresponding ‘yes’ and ‘no’ outcomes).

It will be appreciated that variations of some elements are possible to adapt the invention for specific conditions or functions. The concepts of the present invention can be further extended to a variety of other applications that are clearly within the scope of this invention. Having thus described the present invention with respect to the preferred embodiments as implemented, it will be apparent to those skilled in the art that many modifications and enhancements are possible to the present invention without departing from the basic concepts as described in the preferred embodiment of the present invention. Therefore, what is intended to be protected by way of letters patent should be limited only by the scope of the following claims.

The present invention may be embodied in other specific forms without departing from the spirit or essential characteristics thereof. Therefore, the presently discussed embodiments are considered to be illustrative and not restrictive, the scope of the invention being indicated by the appended claims rather than the foregoing description, and all changes which come within the meaning and range of equivalency of the claims are therefore intended to be embraced therein.

The embodiments of the invention in which an exclusive property or privilege is claimed are defined as follows:

1. A method of selectively apportioning inventory of supplies of a supplier to contracted entities having distribution arrangements with said supplier, comprising:
creating a record of supplies received in said inventory;
from said record of receipt creating availability records of said received supplies for said contracted entities in accordance with said distribution arrangements; and
allocating supplies from said inventory to a contracted entity submitting an order for supplies in accordance with an availability record of said supplies for said contracted entity.

2. The method of claim 1 further comprising allocating portions of said inventory to contracted entities submitting orders for said supplies in accordance with availability records of said supplies for said contracted entities.

3. The method of claim 1 wherein said availability records include one or more priority criteria determined in accordance with said distribution arrangements between said supplier and said contracted entities.

4. The method of claim 3 wherein said priority criteria may comprise one or more of the following factors:
pricing of said supplies;
availability of supplies;
quality of supplies;
history of dealings with said supplier;
locations of said supplier;
responsiveness of said supplier; and,
delivery timing.

5. A method of selectively apportioning inventories of supplies of a plurality of suppliers among a plurality of contracted entities having distribution arrangements with said plurality of suppliers, comprising:
creating records of supplies received in said inventories;
from said records of receipt creating availability records of said received supplies for said contracted entities in accordance with said distribution arrangements; and
allocating supplies from said inventories to said contracted entities submitting orders for said supplies in accordance with availability records of said supplies for contracted entities.

6. The method of claim 5 wherein said availability records include one or more priority criteria determined in accordance with said distribution arrangements between said suppliers and said contracted entities.

7. The method of claim 6 wherein said priority criteria may comprise one or more of the following factors:
pricing of said supplies;
availability of supplies;
quality of supplies;
history of dealings with said supplier;
locations of said supplier;
responsiveness of said supplier; and,
delivery timing.

8. The method of claim 1 wherein said records are created and maintained by said supplier.

9. A method of selectively apportioning inventories of supplies of a plurality of suppliers for a contracted entity which may submit orders for said supplies, in which said contracted entity has distribution arrangements with said suppliers, and said suppliers have availability records of said supplies for said contracted entities in accordance with said distribution arrangements, wherein said availability records include priority criteria, comprising:
identifying distribution arrangements of said contracted entity with said suppliers for said supplies;
obtaining availability records for said supplies from said suppliers; and
submitting orders for selected amounts of said supplies to one or more selected suppliers in accordance with said priority criteria of said availability records.

10. The method of claim 9 in which said distribution arrangements of said contracted entity include a precedence rating for each supplier; and wherein said contracted entity obtains availability records from said suppliers in precedence order.

11. The method of claim 9 in which said distribution arrangements of said contracted entity include precedence ratings for said suppliers; and wherein said contracted entity places orders with said suppliers in precedence order.

12. The method of claim 9 wherein said suppliers include other contracted entities that have distribution arrangements with other contracted entities.

13. The method of claim 1 wherein said distribution agreements indicate a period of time indicating enforcement of said distribution arrangement.

14. A system for selectively apportioning inventory of supplies of a supplier to contracted entities having distribution arrangements with said supplier, said system comprising:
means for creating a record of supplies received in said inventory;
means for creating availability records of said received supplies from said record of receipt for said contracted entities in accordance with said distribution arrangements; and
means for allocating supplies from said inventory to a contracted entity submitting an order for supplies in accordance with an availability record of said supplies for said contracted entity.

15. The system of claim 14 further comprising means for allocating portions of said inventory to contracted entities submitting orders for said supplies in accordance with availability records of said supplies for said contracted entities.

16. The system of claim 14 wherein said availability records include one or more priority criteria determined in accordance with said distribution arrangements between said supplier and said contracted entities.

17. The system of claim 16 wherein said priority criteria may comprise one or more of the following factors:
pricing of said supplies;
availability of supplies;
quality of supplies;
history of dealings with said supplier;
locations of said supplier;
responsiveness of said supplier; and,
delivery timing.

18. A system for selectively apportioning inventories of supplies of a plurality of suppliers among a plurality of contracted entities having distribution arrangements with said plurality of suppliers, comprising:
means for creating records of supplies received in said inventories;
means for creating availability records of said received supplies from said records of receipt for said contracted entities in accordance with said distribution arrangements; and
means for allocating supplies from said inventories to said contracted entities submitting orders for said supplies in accordance with availability records of said supplies for contracted entities.

19. The system of claim 18 wherein said availability records include one or more priority criteria determined in accordance with said distribution arrangements between said suppliers and said contracted entities.

20. The system of claim 19 wherein said priority criteria may comprise one or more of the following factors:
pricing of said supplies;
availability of supplies;
quality of supplies;
history of dealings with said supplier;
locations of said supplier;
responsiveness of said supplier; and,
delivery timing.

21. The system of claim 14 wherein said records are created and maintained by said supplier.

22. A system for selectively apportioning inventories of supplies of a plurality of suppliers for a contracted entity which may submit orders for said supplies, in which said contracted entity has distribution arrangements with said suppliers, and said suppliers have availability records of said supplies for said contracted entities in accordance with said distribution arrangements, wherein said availability records include priority criteria, comprising:
means for identifying distribution arrangements of said contracted entity with said suppliers for said supplies;
means for obtaining availability records for said supplies from said suppliers; and
means for submitting orders for selected amounts of said supplies to one or more selected suppliers in accordance with said priority criteria of said availability records.

23. The system of claim 22 in which said distribution arrangements of said contracted entity include a precedence rating for each supplier; and wherein said contracted entity obtains availability records from said suppliers in precedence order.

24. The system of claim 22 in which said distribution arrangements of said contracted entity include precedence ratings for said suppliers; and wherein said contracted entity places orders with said suppliers in precedence order.

25. The system of claim 22 wherein said suppliers include other contracted entities that have distribution arrangements with other contracted entities.

26. The system of claim 14 wherein said distribution agreements indicate a period of time indicating enforcement of said distribution arrangement.

27. A computer program product for use in a computer system operatively coupled to a computer readable memory, the computer program product including a computer-readable data storage medium tangibly embodying computer readable program code for directing said computer to selectively apportion inventory of supplies of a supplier to contracted entities having distribution arrangements with said supplier, said computer program product comprising code for instructing said computer system to create a record of supplies received in said inventory;
code for instructing said computer system to create availability records of said received supplies from said record of receipt for said contracted entities in accordance with said distribution arrangements; and
code for instructing said computer system to allocate supplies from said inventory to a contracted entity submitting an order for supplies in accordance with an availability record of said supplies for said contracted entity.

28. The computer program product of claim 27 further comprising code for instructing said computer system to allocate portions of said inventory to contracted entities submitting orders for said supplies in accordance with availability records of said supplies for said contracted entities.

29. The computer program product of claim 27 wherein said availability records include one or more priority criteria determined in accordance with said distribution arrangements between said supplier and said contracted entities.

30. The computer program product of claim 29 wherein said priority criteria may comprise one or more of the following factors:
pricing of said supplies;
availability of supplies;
quality of supplies;
history of dealings with said supplier;
locations of said supplier;
responsiveness of said supplier; and,
delivery timing.

31. A computer program product for use in a computer system operatively coupled to a computer readable memory, the computer program product including a computer-readable data storage medium tangibly embodying computer readable program code for directing said computer to selectively apportion inventories of supplies of a plurality of suppliers among a plurality of contracted entities having distribution arrangements with said plurality of suppliers, said computer program product comprising: code for instructing said computer system to create records of supplies received in said inventories;
code for instructing said computer system to create availability records of said received supplies from said records of receipt for said contracted entities in accordance with said distribution arrangements; and
code for instructing said computer system to allocate supplies from said inventories to said contracted entities submitting orders for said supplies in accordance with availability records of said supplies for contracted entities.

32. The computer program product of claim 31 wherein said availability records include one or more priority criteria determined in accordance with said distribution arrangements between said suppliers and said contracted entities.

33. The computer program product of claim 32 wherein said priority criteria may comprise one or more of the following factors:
pricing of said supplies;
availability of supplies;
quality of supplies;
history of dealings with said supplier;
locations of said supplier;
responsiveness of said supplier; and,
delivery timing.

34. The computer program product of claim 27 wherein said records are created and maintained by said supplier.

35. A computer program product for use in a computer system operatively coupled to a computer readable memory, the computer program product including a computer-readable data storage medium tangibly embodying computer readable program code for directing said computer to selectively apportion inventories of supplies of a plurality of suppliers for a contracted entity which may submit orders for said supplies, in which said contracted entity has distribution arrangements with said suppliers, and said suppliers have availability records of said supplies for said contracted entities in accordance with said distribution arrangements, wherein said availability records include priority criteria, said computer program product comprising:
code for instructing said computer system to identify distribution arrangements of said contracted entity with said suppliers for said supplies;
code for instructing said computer system to obtain availability records for said supplies from said suppliers; and
code for instructing said computer system to submit orders for selected amounts of said supplies to one or more selected suppliers in accordance with said priority criteria of said availability records.

36. The computer program product of claim 35 in which said distribution arrangements of said contracted entity include a precedence rating for each supplier; and wherein said contracted entity obtains availability records from said suppliers in precedence order.

37. The computer program product of claim 35 in which said distribution arrangements of said contracted entity include precedence ratings for said suppliers; and wherein said contracted entity places orders with said suppliers in precedence order.

38. The computer program product of claim 35 wherein said suppliers include other contracted entities that have distribution arrangements with other contracted entities.

39. The computer program product of claim 27 wherein said distribution agreements indicate a period of time indicating enforcement of said distribution arrangement.
